(19) United States
(12) Patent Application Publication
(10) Pub. No.: US 2019/0063253 A1
(43) Pub. Date: Feb. 28, 2019

(54) ON-WING ENGINE FLUID SENSING AND CONTROL

(71) Applicant: Rolls-Royce Corporation, Indianapolis, IN (US)

(72) Inventors: Dawn K. Andrus, Avon, IN (US); Michael T. Elliott, Westfield, IN (US); John Costello, Indianaoplis, IN (US); Anthony Fulford, Greenwood, IN (US); John Gebhard, Fishers, IN (US)

(21) Appl. No.: 15/686,925

(22) Filed: Aug. 25, 2017

(51) Int. Cl. F01D 17/02; F01D 25/18; F02C 7/22; G01M 15/14

(52) U.S. Cl. CPC F01D 17/02; F01D 25/18; F05D 2260/98; G01M 15/14; F02C 7/22

(57) ABSTRACT

Technologies for engine fluid quality monitoring are disclosed herein. An engine system includes a sensor and an engine controller. The sensor generates sensor data indicative of a fluid property of engine fluid of a gas turbine engine of the engine system. The engine fluid may be engine oil or fuel. The fluid quality may be viscosity, water content, calorific content, specific gravity, heating value, or the presence of contaminants in the engine fluid. The engine controller determines the fluid property based on the sensor data and outputs the fluid property. The fluid property may be stored in non-volatile storage. A user alert such as a cockpit alert may be generated based on the fluid property. A control law of the gas turbine engine may be modified as a function of the fluid property. The engine controller may include the sensor.

### FIELD OF THE DISCLOSURE

The present disclosure relates generally to sensors and control systems used in gas turbine engine systems, and more specifically to engine fluid quality monitoring and control.

### BACKGROUND

Gas turbine propulsion systems are used to power aircraft, watercraft, power generators, and the like. A typical gas turbine propulsion system includes a gas turbine engine subsystem, an electrical power generation subsystem, a thermal management subsystem, and a lubrication subsystem.

Gas turbine engine subsystems generally include a compressor, a combustor, and a turbine. The compressor compresses air drawn into the engine and delivers high pressure air to the combustor. In the combustor, fuel is mixed with the high pressure air and is ignited. Products of the combustion reaction in the combustor are directed into the turbine where work is extracted to drive the compressor and, sometimes, an output shaft. The output shaft may drive other subsystems of the propulsion system, including the electrical power generation subsystem. Left-over products of the combustion are exhausted out of the turbine and may provide thrust in some applications. Gas turbine engines may use multiple types of engine fluids, such as lubricating oil, hydraulic fluid, fuel, and/or other engine fluids.

### SUMMARY

The present disclosure may comprise one or more of the following features and combinations thereof.

An engine system for engine fluid quality monitoring may include a sensor to generate sensor data indicative of a fluid property of engine fluid of a gas turbine engine of the engine system and an engine controller. The engine controller is configured to determine the fluid property based on the sensor data and output the fluid property in response to a determination of the fluid property. In some embodiments, the engine controller may include the sensor.

In some embodiments, to determine the fluid property may include to detect a contaminant in the engine fluid. In some embodiments, to determine the fluid property may include to determine a viscosity, a water content, a calorific content, or a specific gravity of the engine fluid. In some embodiments, the engine fluid may include engine oil. In some embodiments, the engine fluid may include fuel. In some embodiments, to determine the fluid property may include to determine a heating value of the fuel.

In some embodiments, to output the fluid property may include to record the fluid property in non-volatile storage of the engine system. In some embodiments, to output the fluid property may include to generate a user alert based on the fluid property.

According to another aspect of the present disclosure, a method for engine fluid quality monitoring may include generating, by a sensor, sensor data indicative of a fluid property of engine fluid of a gas turbine engine; determining, by an engine controller, the fluid property based on the sensor data; and outputting, by the engine controller, the fluid property in response to determining the fluid property.

In some embodiments, determining the fluid property may include detecting a contaminant in the engine fluid. In some embodiments, determining the fluid property may include determining a viscosity, a water content, a calorific content, or a specific gravity of the engine fluid. In some embodiments, the engine fluid may include engine oil. In some embodiments, the engine fluid may include fuel. In some embodiments, determining the fluid property may include determining a heating value of the fuel. In some embodiments, the engine fluid may include hydraulic fluid.

In some embodiments, outputting the fluid property may include recording the fluid property in non-volatile storage. In some embodiments, outputting the fluid property may include generating a user alert based on the fluid property. In some embodiments, outputting the fluid property may include modifying a control law of the gas turbine engine as a function of the fluid property.

According to another aspect of the present disclosure, an engine controller may include fluid sensing logic to receive sensor data indicative of a fluid property of engine fluid of a gas turbine engine; determine the fluid property based on the sensor data; and output the fluid property in response to determining of the fluid property.

In some embodiments, to determine the fluid property may include to detect a contaminant in the engine fluid. In some embodiments, to determine the fluid property may include to determine a viscosity, a water content, a calorific content, or a specific gravity of the engine fluid. In some embodiments, the engine fluid may include engine oil. In some embodiments, the engine fluid may include fuel. In some embodiments, to determine the fluid property may include to determine a heating value of the fuel. In some embodiments, the engine fluid may include hydraulic fluid.

In some embodiments, to output the fluid property may include to record the fluid property in non-volatile storage of the engine controller. In some embodiments, to output the fluid property may include to generate a user alert based on the fluid property. In some embodiments, the engine controller may further include control logic to modify a control law of the gas turbine engine as a function of the fluid property.

These and other features of the present disclosure will become more apparent from the following description of the illustrative embodiments.

### BRIEF DESCRIPTION OF THE DRAWINGS

FIG. 1 is a simplified block diagram of at least one embodiment of a gas turbine engine system for a vehicle;

FIG. 2 is a simplified flow diagram of at least one embodiment of a method for fluid sensing and control that may be executed with the system of FIG. 1; and

FIG. 3 is a simplified block diagram of at least one embodiment of an engine controller of FIG. 1.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

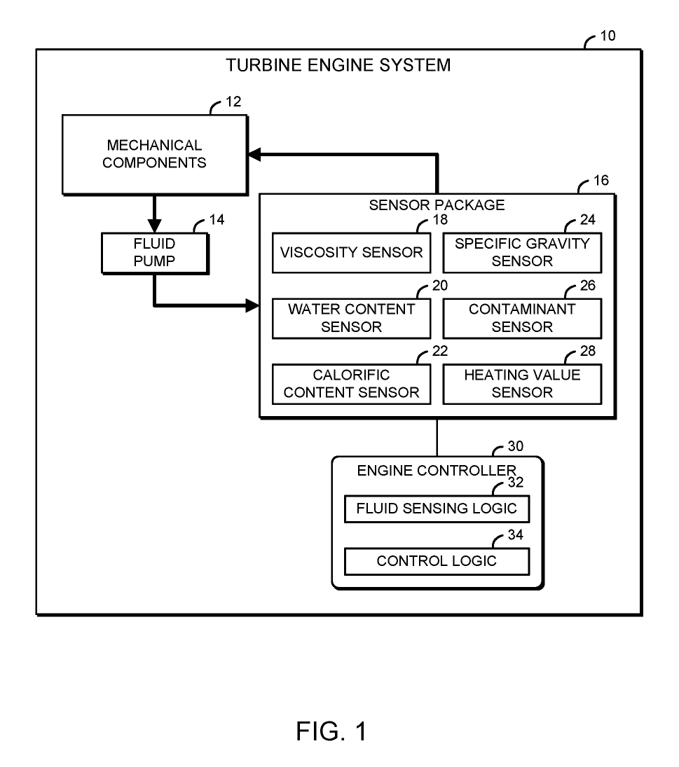

Referring now to FIG. 1, embodiments of a turbine engine system 10 adapted to provide thrust or power to a vehicle include mechanical components 12, a fluid pump 14, a sensor package 16, and an engine controller 30. The engine controller 30 may be embodied as any microcontroller, microprocessor, embedded system, smart sensor, or other computing device capable of performing the functions described herein. In the illustrative embodiment, in addition to various other sensing and control operations, the engine controller 30 electronically analyzes one or more properties of engine fluid of the turbine engine system 10.

The turbine engine system 10 may be adapted to provide thrust or shaft power to an associated vehicle or system (e.g. an airplane, ship, generator, pump, or the like). In particular, the turbine engine system 10 may include a gas turbine engine including associated mechanical components 12, such as a compressor, a combustor, a turbine, a gearbox, various shafts, and other components typically included in a gas turbine engine. The mechanical components 12 may also include one or more generators, alternators, or other electrical machines capable of converting kinetic and/or thermal energy generated by the gas turbine engine into electrical energy.

The turbine engine system 10 may include one or more fluid systems that may be used to distribute and/or use various engine fluids. In particular, the turbine engine system 10 may include a lubrication system that distributes a lubricant such as oil to the mechanical components 12 of the turbine engine system 10 to provide lubrication and/or thermal management. The lubrication system may include one or more lubricant sumps, lubricant circuits, and associated lubricant pumps. The turbine engine system 10 may also include a hydraulic system and a fuel system. The fluid pump 14 may be embodied as any oil pump, hydraulic pump, fuel pump, or other fluid pump that is configured to deliver engine fluid to the sensor package 16. The engine fluid may be pumped through the sensor package 16 to the mechanical components 12, after which the fluid is returned to the fluid pump 14 to complete a fluid circuit.

The sensor package 16 may be embodied as any electronic sensor, smart sensor, or other sensor configured to measure one or more fluid properties of the engine fluid. The sensor package 16 may be coupled to a fluid line, sump, or otherwise configured to receive engine fluid. As shown, in some embodiments, the sensor package 16 may include one or more of a viscosity sensor 18, a water content sensor 20, a calorific content sensor 22, a specific gravity sensor 24, a contaminant sensor 26, and/or a heating value sensor 28.

As shown, the sensor package 16 is communicatively coupled to the engine controller 30. The sensor package 16 and the engine controller 30 may be connected by any network interface, electrical connection, optical connection, wireless connection, or other control interface capable of transmitting sensor data and/or other information from the sensor package 16 to the engine controller 30.

The engine controller 30 may be embodied as any engine control unit, engine monitoring unit, download unit, cockpit display unit, or other computing device capable of performing the functions described herein. In some embodiments, the engine controller 30 may be embodied as a smart sensor that includes one or more sensors of the sensor package 16. In some embodiments, the engine controller 30 may be embodied as a full-authority digital engine controller (FADEC). In addition to various other sensing and control operations, the engine controller 30 may include fluid sensing logic 32 and/or control logic 34.

Each of the fluid sensing logic 32 and the control logic 34 may be embodied as hardware, firmware, software, or a combination thereof. For example, the fluid sensing logic 32 and/or the control logic 34 may form a portion of, or otherwise be established by, a processor or other hardware components of the engine controller 30. As such, in some embodiments, the fluid sensing logic 32 and/or the control logic 34 may be embodied as a circuit or collection of electrical devices (e.g., a fluid sensing logic circuit and/or a control logic circuit).

As described further below, the fluid sensing logic 32 is configured to receive sensor data indicative of a fluid property of engine fluid of a gas turbine engine, determine the fluid property based on the sensor data, and output the fluid property in response to determining of the fluid property. Determining the fluid property may include detecting a contaminant in the engine fluid or determining a viscosity, water content, calorific content, and/or specific gravity of the engine fluid. The engine fluid may be embodied as engine oil or fuel. In some embodiments, determining the fluid property may include determining a heating value of the fuel. Outputting the fluid property may include recording the fluid property in non-volatile storage of the engine controller 30 or generating a user alert based on the fluid property. As described further below, the control logic 34 may be configured to modify a control law of the gas turbine engine as a function of the fluid property.

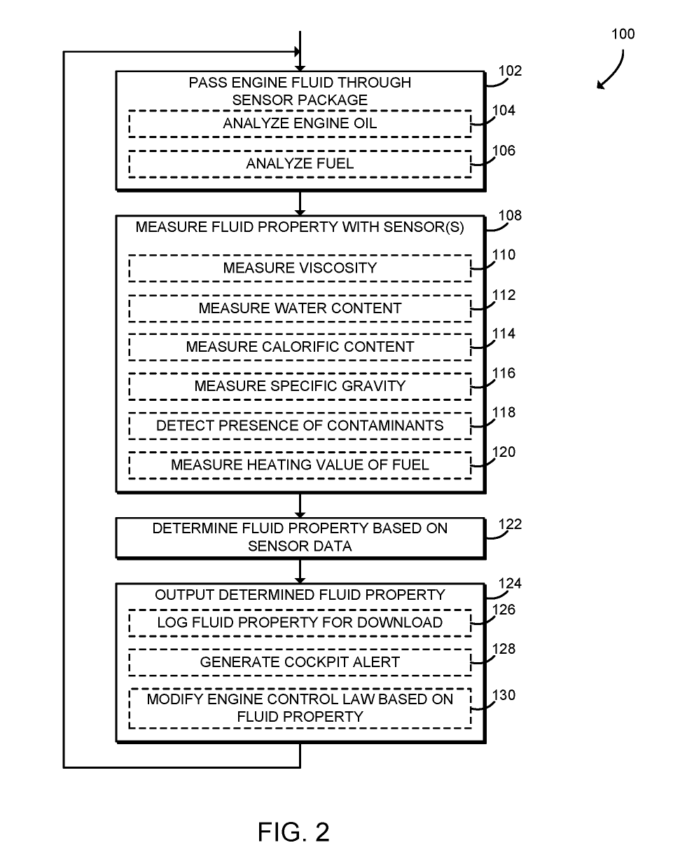

Referring now to FIG. 2, an illustrative method 100 that may be executed by the turbine engine system 10 (e.g., by the engine controller 30) is shown. Aspects of the method 100 may be embodied as electrical circuitry, computerized programs, routines, logic, and/or instructions, such as the fluid sensing logic 32 and/or the control logic 34. The illustrative method 100 may be executed by the turbine engine system 10 in real time during normal operation of a turbine-engine-powered vehicle/system.

The method 100 begins in block 102, in which an engine fluid is passed through the sensor package 16. The engine fluid may be pressurized, for example by the fluid pump 14, and passed through a fluid line, sump, or other fluid passageway to the sensor package 16. In some embodiments, in block 104 the sensor package 16 may analyze engine oil. In some embodiments, in block 106 the sensor package 16 may analyze fuel. Additionally or alternatively, in other embodiments the sensor package 16 may analyze a different engine fluid, such as hydraulic fluid.

In block 108, the sensor package 16 measures one or more fluid properties using one or more associated sensors. After measuring the fluid properties, the sensor package 16 may provide a measurement signal or other sensor data to the engine controller 30. For example, the sensor data may be transmitted via a direct connection, a vehicle network, a wireless connection, or other data connection to the engine controller 30. Of course, in some embodiments the engine controller 30 and the sensor package 16 may be integrated, for example as a smart sensor. In those embodiments, the engine controller 30 may analyze the sensor data and then provide processed results to another controller of the turbine engine system 10. The sensor package 16 may measure any one or more fluid properties based on the available sensors, the type of engine fluid being analyzed, or other factors.

In some embodiments, in block 110, the viscosity sensor 18 may measure viscosity of the engine fluid. Viscosity may be measured, for example, for engine oil. In some embodiments, in block 112, the water content sensor 20 may measure water content of the engine fluid. Water content may be measured, for example, for engine oil and/or fuel. In some embodiments, in block 114, the calorific content sensor 22 may measure calorific content of the engine fluid. Calorific content may be measured, for example, for fuel. In some embodiments, in block 116, the specific gravity sensor 24 may measure specific gravity of the engine fluid. Specific gravity may be measured, for example, for engine oil and/or fuel. In some embodiments, in block 118, the contaminant sensor 26 may detect the presence of contaminants in the engine fluid. Contaminants may include chemicals, metal particles, or other undesirable materials. Contaminants may be detected, for example, in engine oil and/or fuel. In some embodiments, in block 120, the heating value sensor 28 may measure the heating value of the engine fluid. Heating value may be measured, for example, for fuel.

In block 122, the engine controller 30 determines the fluid property based on the sensor data received from the sensor package 16. For example the engine controller 30 may determine viscosity, water content, calorific content, specific gravity, heating value, and/or determine whether contaminants are present in the engine fluid. As described above, in some embodiments the engine controller 30 may be integrated with the sensor package 16, for example as one or more smart sensors. In those embodiments, the determination of the fluid property may thus be performed by one or more smart sensors of the sensor package 16.

In block 124 the engine controller 30 outputs the determined fluid property. The engine controller 30 may use any appropriate technique to output the fluid property, such as presenting the fluid property with one or more displays, storing the fluid property in data storage, transmitting the fluid property to another controller or other computing device of the engine system 10, or otherwise using the determined fluid property. In some embodiments, in block 126 the engine controller 30 may log the fluid property for later download. For example, the engine controller 30 (or another computing device in communication with the engine controller 30) may store the fluid property in non-volatile data storage. The logged fluid property may be later downloaded and analyzed, for example when performing vehicle maintenance. In some embodiments, the engine controller 30 may generate a cockpit alert based on the fluid property. For example, the engine controller 30 (or another computing device in communication with the engine controller 30) may generate an alert to the cockpit to identify potential maintenance required based on the fluid property. In some embodiments, in block 130 the engine controller 30 (or another computing device in communication with the engine controller 30) may modify an engine control law based on the fluid property. For example, the engine controller 30 may modify the engine control law based on the measured heating value of the fuel. Modifying the control law may improve engine performance, fuel efficiency, or otherwise improve performance of the engine system 10. After outputting the determined fluid property, the method 100 loops back to block 102 to continue monitoring fluid properties.

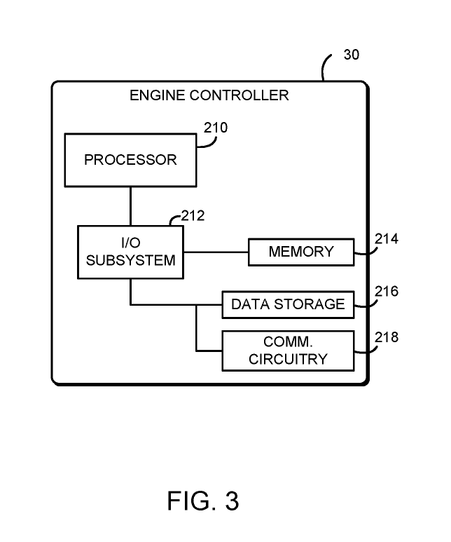

Referring now to FIG. 3, an embodiment of the engine controller 30 is shown. The illustrative engine controller 30 is embodied as one or more computing devices, which may include one or more controllers or processors (e.g., microcontrollers, microprocessors, digital signal processors, field-programmable gate arrays (FPGAs), programmable logic arrays (PLAs), etc.), and/or other electrical circuitry. The engine controller 30 includes hardware, firmware, and/or software components that are capable of performing the functions disclosed herein, including the functions of the fluid sensing logic 32 and/or the control logic 34. The engine controller 30 may be in communication with one or more other devices (such as one or more embedded controllers) by one or more communication networks (not shown), in order to perform one or more of the disclosed functions. Additionally, although illustrated as a single component, it should be understood that in some embodiments the functions of the engine controller 30 may be distributed in multiple components through the turbine engine system 10. Additionally or alternatively, although illustrated as an engine controller 30, it should be understood that those functions may be performed by an engine controller, an engine management unit, an aircraft control system, or any other engine or aircraft control component.

The illustrative engine controller 30 includes at least one processor 210, an input/output (I/O) subsystem 212, and a memory 214. The I/O subsystem 212 typically includes, among other things, an I/O controller, a memory controller, and one or more I/O ports, although not specifically shown. The processor 210 and the I/O subsystem 212 are communicatively coupled to the memory 214. The memory 214 may be embodied as any type of suitable computer memory device (e.g., volatile memory such as various forms of random access memory). The I/O subsystem 212 is communicatively coupled to a number of hardware and/or software components, including a data storage device 216 and communication circuitry 218.

The data storage device 216 may include one or more hard drives or other suitable persistent data storage devices (e.g., flash memory, memory cards, memory sticks, read-only memory devices, and/or others). Information about the different operating conditions of the turbine engine system 10, and/or any other data needed by the turbine engine system 10 (e.g., the fluid sensing logic 32 and/or the control logic 34) may be stored in the data storage device 216. Portions of the fluid sensing logic 32 and/or the control logic 34 may be copied to the memory 214 during operation of the turbine engine system 10, for faster processing or other reasons. The fluid sensing logic 32 and the control logic 34 are embodied as one or more computer-executable components and/or data structures (e.g., computer hardware, firmware, software, or a combination thereof). Particular aspects of the methods that may be performed by the fluid sensing logic 32 and/or the control logic 34 may vary depending on the requirements of a particular design of the turbine engine system 10. Accordingly, the examples described herein are illustrative and intended to be non-limiting.

The communication circuitry 218 may communicatively couple the engine controller 30 to one or more other devices, systems, or communication networks, e.g., a vehicle area network, controller area network, local area network, and/or wide area network, for example. Accordingly, the communication circuitry 218 may include one or more wired or wireless network interface software, firmware, or hardware, for example, as may be needed pursuant to the specifications and/or design of the particular turbine engine system 10. Further, the engine controller 30 may include other components, sub-components, and devices not illustrated herein for clarity of the description. In general, the components of the engine controller 30 are communicatively coupled as shown in FIG. 3 by electronic signal paths, which may be embodied as any type of wired or wireless signal paths capable of facilitating communication between the respective devices and components.

In the foregoing description, numerous specific details, examples, and scenarios are set forth in order to provide a more thorough understanding of the present disclosure. It will be appreciated, however, that embodiments of the disclosure may be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described may include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to effect such feature, structure, or characteristic in connection with other embodiments whether or not explicitly indicated.

Embodiments in accordance with the disclosure may be implemented in hardware, firmware, software, or any combination thereof. Embodiments may also be implemented as instructions stored using one or more machine-readable media, which may be read and executed by one or more processors. A machine-readable medium may include any mechanism for storing or transmitting information in a form readable by a machine. For example, a machine-readable medium may include any suitable form of volatile or non-volatile memory.

Modules, data structures, and the like defined herein are defined as such for ease of discussion, and are not intended to imply that any specific implementation details are required. For example, any of the described modules and/or data structures may be combined or divided into sub-modules, sub-processes or other units of computer code or data as may be required by a particular design or implementation.

In the drawings, specific arrangements or orderings of schematic elements may be shown for ease of description. However, the specific ordering or arrangement of such elements is not meant to imply that a particular order or sequence of processing, or separation of processes, is required in all embodiments. In general, schematic elements used to represent instruction blocks or modules may be implemented using any suitable form of machine-readable instruction, and each such instruction may be implemented using any suitable programming language, library, application programming interface (API), and/or other software development tools or frameworks. Similarly, schematic elements used to represent data or information may be implemented using any suitable electronic arrangement or data structure. Further, some connections, relationships, or associations between elements may be simplified or not shown in the drawings so as not to obscure the disclosure.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

1. An engine system for engine fluid quality monitoring, the engine system comprising:
a sensor to generate sensor data indicative of a fluid property of engine fluid of a gas turbine engine of the engine system; and
an engine controller to (i) determine the fluid property based on the sensor data and (ii) output the fluid property in response to a determination of the fluid property.

2. The engine system of claim 1, wherein to determine the fluid property comprises to detect a contaminant in the engine fluid.

3. The engine system of claim 1, wherein to determine the fluid property comprises to determine a viscosity, a water content, a calorific content, or a specific gravity of the engine fluid.

4. The engine system of claim 1, wherein the engine fluid comprises engine oil.

5. The engine system of claim 1, wherein the engine fluid comprises fuel.

6. The engine system of claim 5, wherein to determine the fluid property comprises to determine a heating value of the fuel.

7. The engine system of claim 1, wherein to output the fluid property comprises to record the fluid property in non-volatile storage of the engine system.

8. The engine system of claim 1, wherein to output the fluid property comprises to generate a user alert based on the fluid property.

9. The engine system of claim 1, wherein to output the fluid property comprises to modify a control law of the gas turbine engine as a function of the fluid property.

10. The engine system of claim 1, wherein the engine controller comprises the sensor.

11. A method for engine fluid quality monitoring, the method comprising:
generating, by a sensor, sensor data indicative of a fluid property of engine fluid of a gas turbine engine;
determining, by an engine controller, the fluid property based on the sensor data; and
outputting, by the engine controller, the fluid property in response to determining the fluid property.

12. The method of claim 11, wherein the engine fluid comprises engine oil.

13. The method of claim 11, wherein the engine fluid comprises fuel.

14. The method of claim 13, wherein determining the fluid property comprises determining a heating value of the fuel.

15. The method of claim 11, wherein outputting the fluid property comprises generating a user alert based on the fluid property.

16. The method of claim 11, wherein outputting the fluid property comprises modifying a control law of the gas turbine engine as a function of the fluid property.

17. An engine controller comprising fluid sensing logic to:
receive sensor data indicative of a fluid property of engine fluid of a gas turbine engine;
determine the fluid property based on the sensor data; and
output the fluid property in response to determining of the fluid property.

18. The engine controller of claim 17, wherein to output the fluid property comprises to record the fluid property in non-volatile storage of the engine controller.

19. The engine controller of claim 17, wherein to output the fluid property comprises to generate a user alert based on the fluid property.

20. The engine controller of claim 17, further comprising control logic to modify a control law of the gas turbine engine as a function of the fluid property.
